(19) United States
(12) Patent Application Publication
(10) Pub. No.: US 2007/0137170 A1
(43) Pub. Date: Jun. 21, 2007

(54) Speed-regulated pressure exchanger

(75) Inventors: Stephan Bross, Erpolzheim (DE); Wolfgang Kochanowski, Windesheim (DE)

Correspondence Address: CROWELL & MORING LLP;INTELLECTUAL PROPERTY GROUP, P.O. BOX 14300, WASHINGTON, DC, 20044-4300, US

(73) Assignee: KSB Aktiengesellschaft, Frankenthal (DE)

(21) Appl. No.: 11/703,238

(22) Filed: Feb. 7, 2007

Related U.S. Application Data
(63) Continuation of application No. PCT/EP05/07649, filed on Jul. 14, 2005.

(30) Foreign Application Priority Data
Aug. 7, 2004 (DE) 10 2004 038 440.1

(51) Int. Cl. F02C 3/02

(52) U.S. Cl. 60/39.45

(57) ABSTRACT

A pressure exchanger for transferring pressure from a higher pressure liquid in a first liquid system to a lower pressure liquid in a second liquid system having a housing (8) with inlet and outlet connection openings (10-10.3) for each liquid and a rotor (1) arranged in the housing for rotation about a longitudinal axis. The rotor has a plurality of through channels (13) arranged around the longitudinal axis with openings (12) on axial end faces (2, 3) of the rotor. The rotor channels (13) are connected to the connection openings (10-10.3) through flow openings (11-11.3) in the housing such that during rotation of the rotor high pressure liquid and low pressure liquid are alternately supplied to the respective systems. A predominantly axially extending flow transition is formed between the flow openings (11-11.3) in the housing and the openings (12) of the rotor channels (13), and the flow openings in the housing form part of curved cavities (19) with each cavity (19) simultaneously covering several rotor channel openings (12) and having a shape which equilibrates the liquid flow speed in the vicinity of the housing flow openings (11-11.3). External surfaces (5-5.3) of the rotor (1) have an energy converting or energy transmitting configuration (6), and a partial flow (TS) of high pressure and/or flow energy impinging on the configuration (6) produces rotation of the rotor (1). A regulator (7) the varies the amount of the partial flow (TS) and the rotational speed of the rotor (1) and controls the rotational speed of the rotor for substantially shock-free admission of the mass flow into the rotor channels (13).

### CROSS REFERENCE TO RELATED APPLICATIONS

This application is a continuation of international patent application no. PCT/EP2005/007649, filed Jul. 14, 2005 designating the United States of America and published in German on Feb. 16, 2006 as WO 2006/015682, the entire disclosure of which is incorporated herein by reference. Priority is claimed based on Federal Republic of Germany patent application no. DE 10 2004 038 440.1, filed Aug. 7, 2004.

### BACKGROUND OF THE INVENTION

The invention relates to a pressure exchanger for transferring pressure energy from a first liquid of a first liquid system to a second liquid of a second liquid system, comprising a housing having connector openings in the form of inlet and outlet openings for each liquid and a rotor arranged to rotate about its longitudinal axis within the housing, the rotor having a plurality of continuous channels with openings arranged around its longitudinal axis on each rotor end face, in which the rotor channels communicate with the connector openings of the housing via flow openings in the housing; the rotor channels alternately carry liquid at a high pressure and liquid at a low pressure for the respective systems during rotation of the rotor; a flow transition extending primarily axially is formed between the flow openings in the housing and the openings of the rotor channels, whereby the flow openings in the housing are parts of cavities constructed in the form of arcs connected to the connector openings and each cavity simultaneously covers multiple openings of the rotor channels.

A known pressure exchanger design is disclosed in European Patent 1 019 636 B1. With this design, high pressure of a first liquid of a first liquid system is transmitted to a second liquid of a second liquid system to achieve an energy recovery in a plant to which the pressure exchanger is connected. This type of pressure exchanger is not equipped with any external drive. To start operation thereof with such a pressure exchanger, a complex method is necessary to set the rotor in rotation. The liquid stream is responsible for the rotational movement of a rotor, passing through flow openings on the housing from an oblique direction and striking the end faces of the rotor with the openings, thereby inducing a momentum drive of the rotor. During ongoing operation in a continuously operated plant, an equilibrium state is established in the pressure exchanger so that the rotor rotates at an approximately constant rotational speed because of this equilibrium state. It is a disadvantage here that this rotational speed is automatically established at an undefined rotational speed value as a function of altered plant conditions on the high pressure side and the low pressure side. Depending on the different boundary conditions in the two liquid systems, this results in different rotational speeds of the rotor and thus different mixing effects of the two liquids that are alternately contained in the rotor channels.

U.S. Pat. Nos. 3,431,747 and 6,537,035 describe a different pressure exchanger design in which an external drive starts the movement of the rotor and the rotor channels are constructed as bores, a separating element in the form of a ball being arranged in each bore. This ball serves to separate the liquids alternately flowing into the rotor channels with a high or low pressure content and prevents mixing of the liquids in the bores. However, disadvantages here include the arrangement, sealing and design of the separation element and the respective seating faces. In addition, a complex high-pressure gasket is necessary as a shaft seal in the area of a shaft bushing for the external drive.

### SUMMARY OF THE INVENTION

An object of the present invention is to provide an improved rotary pressure exchanger.

Another object of the invention is to provide a pressure exchanger having a rotor which does not have any separating elements in the rotor channels.

A further object of the invention is to provide a rotary pressure exchanger which operates with minimal mixing losses in the rotor channels during pressure exchange.

It is also an object of the invention to provide a pressure exchanger which maintains an efficient operating state with minimal mixing losses over a large operating range with variable mass flows.

These and other objects are achieved in accordance with the present invention by providing a pressure exchanger for transferring pressure energy from a high pressure liquid of a first liquid system to a low pressure liquid of a second liquid system comprising a housing with inlet and outlet connection openings for each liquid and a rotor arranged in the housing for rotation about a longitudinal axis, the rotor having a plurality of continuous channels arranged around the longitudinal axis with openings on each rotor end face such that the rotor channels are connected with the inlet and outlet connection openings through flow openings in the housing so that during the rotation of the rotor the channels alternately carry high pressure liquid and low pressure liquid from the respective liquid systems; in which a predominantly axially extending flow transition is formed between the flow openings in the housing and the openings of the rotor channels; the flow openings in the housing are parts of arcuately shaped cavities communicating with the connection openings, and each cavity simultaneously covers a plurality of rotor channel openings and has a contour that smoothes out the velocity of flow in the area of the housing flow openings; the rotor has an outside surface contour that converts or transfers energy such that a partial liquid stream impinging with high pressure energy or flow energy against the rotor contour causes the rotor to rotate, and a regulator varies the amount of the partial stream and the rotational speed of the rotor and adjusts the rotor speed to a speed suitable for essentially shock-free admission of the liquid flow into the rotor channels.

In accordance with the present invention, the cavities have a construction which makes the velocity of flow uniform in the area of the flow opening in the housing; the outside surface of the rotor has a shape which converts energy and/or transmits energy; a partial stream of a high pressure energy and/or flow energy striking this shape generates the rotor rotational speed, and a regulator alters the quantity of the partial stream and the rotational speed of the rotor and regulates the rotor speed at a rotational speed for essentially shock-free admission of the mass flow into the rotor channels. With this approach it is easily possible to take a partial stream from the total mass flow flowing to a pressure exchanger in a plant and with the help of this partial stream to generate a certain drive torque for the rotor. This advantageously facilitates a startup procedure of the rotor. Furthermore, this approach offers an opportunity to create a permanent and regulated torque as the driving momentum for continuous operation of the rotor with the help of the partial stream, the amount of which is adjustable. Thus, in the respective operating state, the rotational speed of the rotor is adapted to the prevailing plant conditions through appropriate variation of the partial stream.

Due to the cavities arranged in the housing with their flow-smoothing contour, i.e., the design, shape and course of the wall surfaces surrounding the cavity, a uniform velocity profile of the main stream is established in transition to the rotor and in front of the openings in the rotor channels receiving the oncoming flow in the area of the flow opening in the housing. This is the mass flow of the main stream reduced by the partial stream. The direct drive of the rotor by the partial stream and the development of a uniform velocity profile in the flow opening in the housing yield the advantage that the main stream reaches the rotor channels essentially shock-free. And if a change in the mass flow is also established because of altered plant conditions at the pressure exchanger, i.e., there is a change in mass flow toward a higher or lower flow rate, then there is an adjustment of the rotor speed with a suitably modified partial stream to continue to ensure a substantially shock-free oncoming flow of the main stream is admitted to the rotor channels.

And a uniform velocity profile of the channel flow situated therein is also established in the cross section of the rotor channels due to the uniform flow distribution of the main stream upstream from the openings of the rotor channels. As a result of this, this yields a smaller and more stable mixing zone in the area between the two liquids with their different properties within the rotor channels. This improves the efficiency of such a pressure exchanger and a plant which is influenced thereby. The partial stream used for driving the rotor flows out into a lower pressure zone within the pressure exchanger, i.e., in this case into the second liquid system.

The quantity of the partial stream and the speed of the rotor are adjusted by the regulator. Thus the rotor speed is automatically matched to varying plant conditions. The efficiency of a pressure exchanger in a plant, e.g., a reverse osmosis plant, is thus always kept at the best operating point.

According to preferred embodiments of the invention, a contour arranged in the surface of the rotor is designed as a plurality of distributed blade elements or a plurality of blade elements is arranged in distribution in the area of one or both rotor end faces. These may be arranged only on the end faces as well as in the area of the transitions between the end faces and the circumferential surface. The same functionality is obtained when the shape on the rotor circumference is designed as one or more spiral grooves.

According to additional embodiments, at least one partial stream derived from the first liquid system flows toward the rotor surface contour. This yields a direct flow drive of the rotor. And a mass flow reduced by a partial stream flows as a main stream of the liquids toward the rotor channels essentially without shock.

The liquids circulating within the pressure exchanger are defined here as follows:

The first liquid and the first liquid system have a high pressure. The second liquid and the second liquid system have a low pressure. A total quantity of liquid flowing to the pressure exchanger, e.g., a liquid flowing out of a reverse osmosis module at a high pressure, corresponds to the mass flow to be processed by the pressure exchanger. A partial stream which is directed at the contour and with the help of which the rotor is driven branches off from the mass flow having a high pressure. A partial stream at a lower pressure, whose energy content is thereby reduced by the drive work on the rotor, flows through the gap between the rotor and the housing or through a separate drain into the second liquid system and ultimately out to the atmosphere. For the purpose of pressure exchange, the main stream, the size of which corresponds to the mass flow reduced by the partial stream, flows into the rotor of the pressure exchanger. And the energy converting shape is constructed as a plurality of blade elements or spiral grooves.

With altered plant conditions, the oncoming flow to the rotor channels is essentially shock-free with an adjusted rotor speed for the main stream. This prevents mixing in the rotor channels. And the cavities which are crucial for a uniform velocity profile upstream from the rotor each comprise a diffuser part downstream from the connector openings and a following deflector part and include the flow opening in the housing. With the help of the deflector part, the influence is compensated by the circumferential component of the rotor in a developing velocity profile. And with the diffuser part, the velocity distribution of the flow in the cavity is made more uniform. The transition between the diffuser part and the deflector part may be designed in stages or continuously.

A regulator arranged in the lines of the partial stream acts as a throttle mechanism to alter the flow rate of the partial stream. Thus the rotational speed of the rotor and therefore the efficiency of the pressure exchanger are easily adapted to the respective plant conditions. The partial mass which acts directly on the blade elements of the rotor and thus influences its rotational speed changes as a result of a change in the adjustment by the regulator.

Another embodiment relates to a pressure exchanger of the foregoing type in which an external drive drives the rotor via a shaft. According to the solution to the problem with such an embodiment, the cavities have a shape that makes the velocity of flow more uniform in the area of the flow opening in the housing, and a regulator is provided as a speed regulating device for the external drive, and thus the rotor speed can be regulated at a rotational speed suitable for essentially shock-free admission of the mass flow into the rotor channels as a function of the plant conditions. Thus, the total mass flow of the incoming high pressure flow (HP-in) flows into rotor channels essentially without any shock or impact. Which drive concept is the most advantageous for a given rotor will depend on the conditions prevailing at the site of use.

Sensor elements arranged in the liquid systems monitor the operating states, and a regulating device connected to the sensor elements adjusts the partial stream and/or the rotor speed to the altered operating states when deviations occur.

With one device, the regulating device detects the rotational speeds of the rotor and generates from the rotor speeds appropriate actuating signals for a speed control of one or more pumps in the first and/or second liquid system. This makes it possible to regulate the pumps which generate the pressure in one plant, for example. This may be accomplished by an essentially known electronic actuator which, based on the rotor speed of the pressure exchanger, adjusts the flow rate and/or speed of one or more rotary pumps to altered plant conditions with the help of actuating signals delivered via the device to be processed. This yields improved economic operating conditions.

In addition, a regulator connected downstream from the pressure exchanger in a line for the outgoing low pressure liquid stream (LP-out) adapts the incoming low pressure liquid stream (LP-in) to the enriched high pressure liquid stream (HP-out) via the regulating device.

### BRIEF DESCRIPTION OF THE DRAWINGS

The invention will be described in further detail hereinafter with reference to illustrative preferred embodiments shown in the accompanying drawing figures, in which:

FIG. 1 shows a schematic diagram of a rotor drive with a partial stream;

FIG. 2 shows a section through a pressure exchanger according to FIG. 1;

FIG. 3 shows a perspective view of a rotor;

FIGS. 4 and 5 show different schematic diagrams of the rotor drawing;

FIG. 6 shows a section through a pressure exchanger with grooves provided on the rotor;

FIG. 7 shows a sectional view taken along line VII-VII of FIG. 6;

FIG. 8 shows a schematic diagram of the flow paths inside the pressure exchanger;

FIG. 9 shows a developed view of the flow paths arranged in the housing of the pressure exchanger, and FIG. 10 shows a flow diagram of a plant with a pressure exchanger.

### DETAILED DESCRIPTION OF PREFERRED EMBODIMENTS

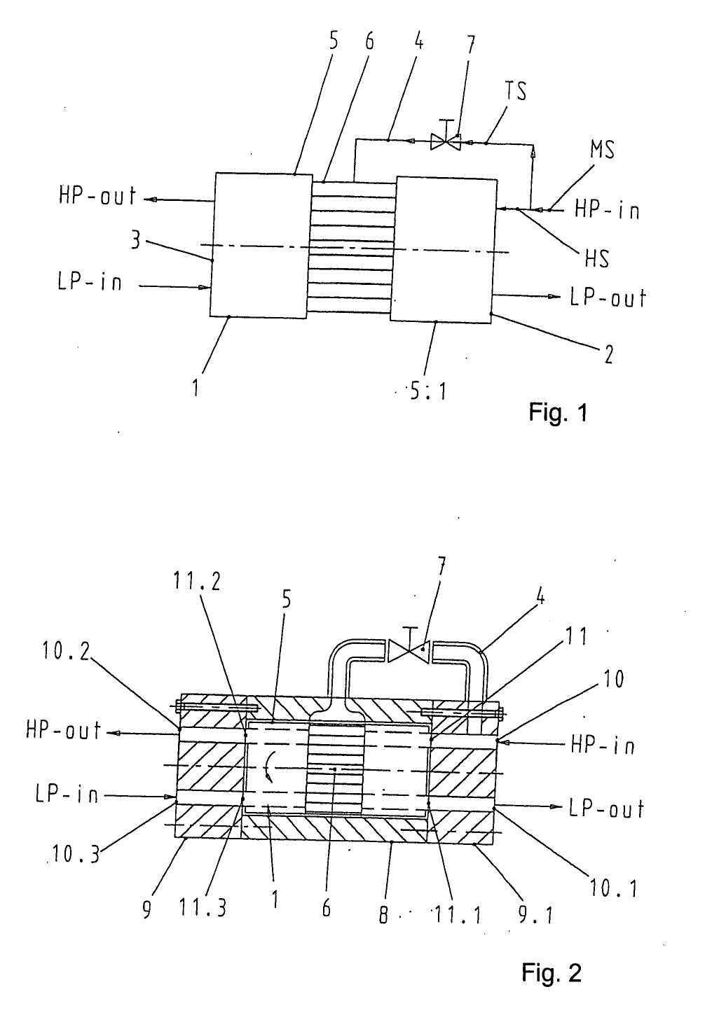

FIG. 1 shows a cylindrical rotor 1 of a pressure exchanger. It is shown in a view from above with the axis of rotation line in the plane of the drawing and, for reasons of simplicity, the other housing parts which surround the rotor and in which the flow guides are arranged have been omitted. The arrows represent the directions of flow and the various liquids which are in operative connection with the rotor. On a rotor end face 2, the arrow HP-in indicates the direction of flow of a first liquid having a high pressure that is to be transferred to a second liquid LP-in flowing into the rotor 1 on the other rotor end face 3. After the transfer of pressure from HP-in to LP-in, which takes place in the pressure exchanger due to the rotation of rotor 1, a liquid whose pressure has been increased flows out of the pressure exchanger as HP-out on the rotor end face 3 and flows back to a plant. On the rotor end face 2, which is on the right here, an arrow LP-out pointing away from the rotor 1 represents the direction of flow of the second liquid LP-out at a lower pressure level having a lower energy content leaving the rotor 1. This is the original HP-in whose pressure energy has been transferred and is now flowing out as low-energy LP-out. The abbreviations LP and HP stand for low pressure and high pressure. The designators “out” and “in” indicate the direction of flow away from or toward the rotor.

The flow arrow for HP-in corresponds to a vector for the total mass flow MS. A partial stream TS branches off from the mass flow MS, and the mass flow MS reduced by this amount flows as a main stream HS into rotor 1. The partial stream TS is passed through internal or external lines 4 to the surface 5 of the rotor 1 where a contour 6 that transfers energy is arranged. The partial stream TS used for driving the rotor 1 flows out into a zone of lower pressure within the pressure exchanger, i.e., into the second liquid system.

In this example, the contour 6 is arranged centrally on the surface 5 of the rotor 1, resulting in two symmetrical partial surfaces 5 and 5.1. A regulator 7 provided in the line 4 helps to influence the quantity of partial stream TS flowing through the line 4 so that the speed of the rotor 1 is controlled and regulated directly. The contour 6 here may have any suitable shape to convert a partial stream TS of a high pressure energy and/or flow energy acting thereon into a driving momentum for the rotor 1.

FIG. 2 shows a housing 8 of the pressure exchanger with a rotor 1 arranged therein. Sealing plates 9 and 9.1 having a total of four connection openings 10-10.3 are arranged on the end faces of the housing 8, which serve as inlet and outlet openings for the two liquid systems connected to the pressure exchanger. The rotor 1 is mounted with its surface 5 inside the housing 8. At the transition between the sealing plates 9, 9.1 and the rotor 1, there are four flow openings 11-11.3 in the housing through which a liquid exchange takes place between the rotor 1 and the sealing plates 9 and 9.1.

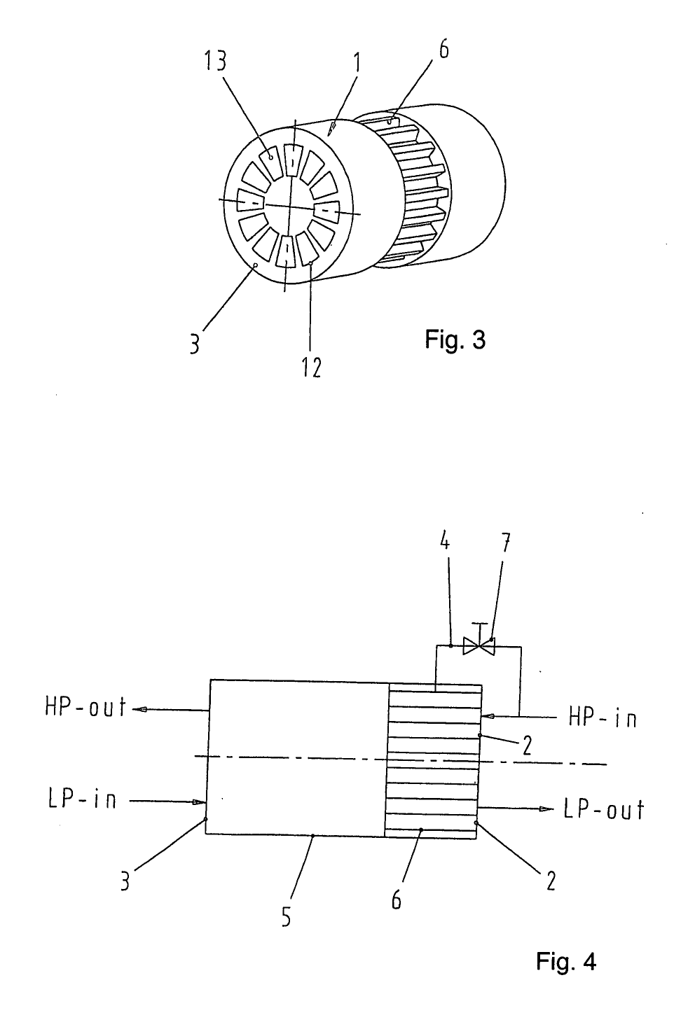

FIG. 3 shows a perspective view of a rotor 1, where it can be seen that the contour 6 onto which a high-energy partial stream TS, i.e., a partial stream having a high pressure, is directed to create a driving torque, may be constructed as a series of blades or the like. Any known type or configuration of pressure transmitting blade may be used here. The openings 12 of the uniformly distributed rotor channels 13 are located in the rotor end face 3. In this illustrative embodiment, the rotor channels and their openings 12 have a trapezoidal cross section so that there are wall surfaces constructed as radially extending webs between the rotor channels. Other cross-sectional shapes of the rotor channels 13 are, of course, also possible. However, the shape shown here has the advantage that it has the largest opening volume.

FIG. 4 shows a modification of the diagram of FIG. 1. In this embodiment, an energy transferring contour 6 is arranged on the surface 5 of the rotor 1 in the area adjacent the rotor end face 2.

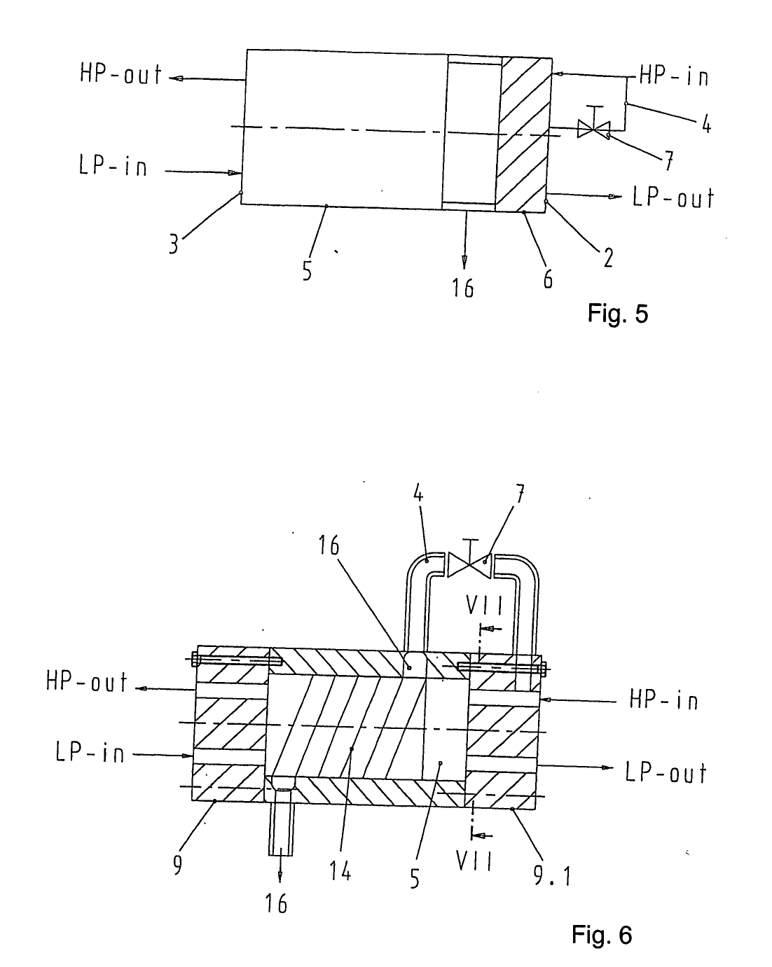

In the diagram of FIG. 5, the partial stream TS is directed via the lines 4 and the regulator 7 in an axial direction onto the contour 6, which in this case is on the rotor end face. The contour 6 extends into the surface 5 of the rotor 1 and is constructed with blades which induce a deflection of the axially oncoming flow of the partial stream TS and create a driving momentum in the circumferential direction of the rotor 1.

FIG. 6 shows a modification of the pressure exchanger in which one or more spiral grooves 14 in the surface 5 of the rotor 1 assume the function of the energy-transferring contour 6. The partial stream is fed through the line 4 into the spiral grooves 14, creating therein a driving momentum for the rotor 1 due to the reactive forces acting there and triggering the rotational movement. The incoming flow of the partial stream into the spiral grooves 14 takes place through an incoming flow gap 15 arranged tangentially to the rotor surface 5. The partial stream flows out of the spiral grooves 14 into a zone 16 having a lower pressure level. The rotational speed of the rotor is adjusted with the aid of a speed regulator 7, which influences the volume flow of the partial stream.

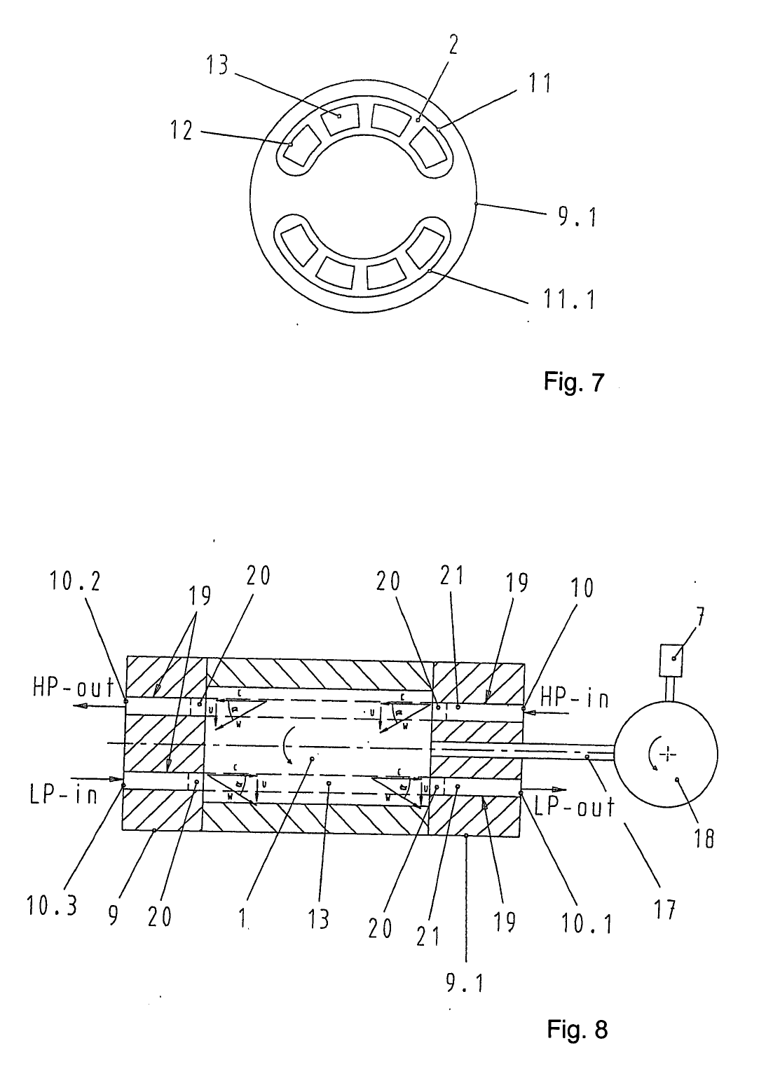

FIG. 7 is a sectional view taken along line VII-VII of FIG. 6 and shows a view of the rotor end face 2 through the flow openings 11 and 11.1 in the housing. These flow openings are arranged in the sealing plate 9.1, run in the shape of a curve, and surround a plurality of openings 12 of the rotor channels 13. The flow openings 11 and 11.1 are components of cavities which are arranged in the sealing plate 9.1 and through which the liquids flow to or from the rotor 1.

FIG. 8 shows a modification of a pressure exchanger with which the rotor 1 is set in rotation by an external drive device 18 via a shaft 17. This may be a motor, a turbine or the like. The contour and the lines for the partial stream are omitted in this embodiment. Instead the regulator 7 acts directly on the drive device 18. In this embodiment, the total mass flow MS flows through the connector openings into the cavities 19 situated in the sealing plates 9 and 9.1. These cavities have downstream diffuser parts 21 over the connector openings 10-10.3 and have deflector parts 20 containing flow openings 11-11.3 in the housing connected thereto. The deflector parts expand spatially in the form of a diffuser in the direction of the flow openings 11-11.3 in the housing.

Because of the rotor rotating at circumferential velocity u, the direction of through flow is constantly changing in the channels 13 of the rotor. To achieve the same conditions, the diffuser part 21 and the deflector part 20 are arranged symmetrically, i.e., mirror symmetry. The velocity triangle diagrams depicted in FIG. 8 are shown tilted by 90°. In actuality, the angle a and the circumferential velocity u at these locations are perpendicular to the plane of the drawing in accordance with the direction of rotation. In the velocity triangle diagrams, the vector c indicates the relative velocity in the axial direction in the rotating system. The vector u indicates the circumferential component U of the flow in the rotating system, and the vector w represents the incoming flow velocity of the stationary system in the transition to the rotating system. The vector w with the vector c forms the incoming flow angle α, which is actually perpendicular to the plane of the drawing. Liquid flowing into the rotor 1 with the absolute velocity w in the nonrotating system corresponds to the total mass flow MS comprising the partial stream TS and the main stream HS.

The flow openings 11-11.3 in the housing have an essentially bean-shaped cross section. The rounded areas on their two ends are tangential to a radius to the longitudinal axis. The wall surfaces of the deflector part 20 developing into the rounded areas extend at the angle a in the axial direction of the cavity 19. A shock-free incoming flow into the rotor channels at the angle α is obtained with the deflector part 20 and the velocity profile of the flow that has been smoothed at the openings 12 of the rotor channels 13. This reliably prevents mixing within the rotor channels 13 in the area of a separation zone between the two different liquids inside the rotor channel.

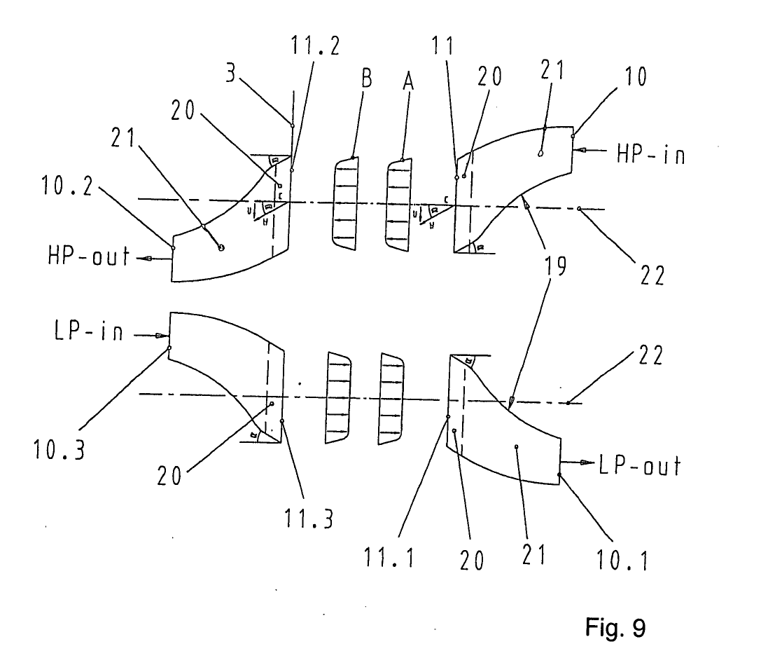

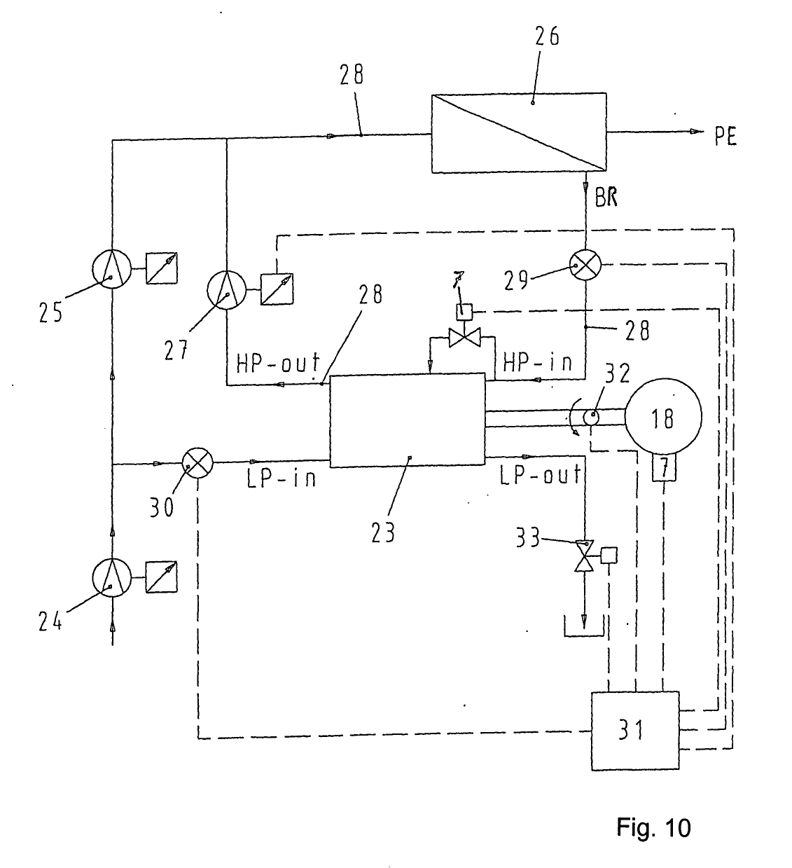

FIG. 9 shows a developed view of the cavities 19 in the sealing plates 9, 9.1 over the longitudinal axis 22 of the rotor, shown with a broken line. A main stream or mass flow flowing in through the connector opening 10 independently of the type of drive of the rotor enters the cavity 19 and its diffuser part 21. There is already a smoothing of the velocity of flow here. This achieves a uniform velocity distribution in the area of the deflector part 20 with its flow opening 11 in the housing opposite the rotor end face 2, as shown in the velocity triangle diagram A. A uniform flow through the rotor channels 13 results due to the uniform distribution of the velocity of flow and its oncoming flow into the rotor channels 13 at the angle α. Therefore, mixing within the rotor channels and in the zone of the two liquids encountering one another is prevented. On the other rotor end face 3, a similar velocity distribution is established according to diagram B. The flow enters the deflector part 20 through the flow opening 11.2 in the housing and flows through the diffuser 21, through which the flow is now passing in reverse and which thus assumes a nozzle function, then flows out as HP-out through the connector opening 10.2. The diagram at the bottom of FIG. 9 shows a similar situation in the area of the direction of flow LP-in and LP-out.

FIG. 10 shows a flow chart of a reverse osmosis system equipped with a pressure exchanger 23. A feed pump 24 delivers a feed liquid into the plant. A portion of this feed liquid is sent from a high-pressure pump 25 directly to a reverse osmosis module 26 in which a type of flow division takes place because a liquid component flows out of the module 26 as purified liquid, the so-called permeate (PE). The remaining liquid component, the so-called brine (BR), flows at a high pressure to pressure exchanger 23, where the high-pressure component of the brine (BR) is transferred to the other portion of the feed liquid which is conveyed by the feed pump 24 and is to be processed. This quantity corresponds in amount to the permeate (PE) flowing out of the system. Thus a circulation pump 27 downstream from the pressure exchanger 23 need only develop a low delivery pressure which corresponds approximately to the pressure drop in the circulation 28. Sensor elements or flow meters 29 and 30 are provided in the inlet lines to the pressure exchanger 23 for HP-in and LP-in. These components 29 and 30 provided in the liquid systems monitor the operating states, and whenever deviations occur, a regulating unit 31 connected thereto adjusts the partial flow TS and/or the rotor speed to the altered operating states via the regulating unit 7. The amount of HP-out flowing out of the pressure exchanger 23 must match the amount of LP-in flowing into the pressure exchanger in order to avoid overflow into the rotor channels. The mass flow LP-in is measured with the sensor or flow meter 30, and HP-out is adjusted to LP-in by the regulating device 31 and regulator 33 based on the measured signals.

The two possible types of drives are shown on the pressure exchanger 23 only for the sake of illustration. In practice, the rotor drive takes place via the partial stream or the drive 18. The regulating device 30 and/or a device 31 may also detect the rotational speeds of the rotor and may generate actuating signals for a speed control corresponding to the rotor speeds by one or more of pumps 24, 25 or 27 in the first and/or second liquid systems.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A pressure exchanger for transferring pressure energy from a high pressure liquid of a first liquid system to a low pressure liquid of a second liquid system comprising a housing with inlet and outlet connection openings for each liquid and a rotor arranged in the housing for rotation about a longitudinal axis, said rotor having a plurality of continuous channels arranged around the longitudinal axis with openings on each rotor end face such that the rotor channels are connected with the inlet and outlet connection openings through flow openings in the housing so that during the rotation of the rotor the channels alternately carry high pressure liquid and low pressure liquid from the respective liquid systems; wherein:
a predominantly axially extending flow transition is formed between the flow openings in the housing and the openings of the rotor channels;
the flow openings in the housing are parts of arcuately shaped cavities communicating with the connection openings, and each cavity simultaneously covers a plurality of rotor channel openings and has a contour that smoothes out the velocity of flow in the area of the housing flow openings;
the rotor has an outside surface contour that converts or transfers energy such that a partial stream impinging with high pressure energy or flow energy against the rotor contour causes the rotor to rotate, and
a regulator varies the amount of the partial stream and the rotational speed of the rotor and adjusts the rotor speed for essentially shock-free admission of the liquid flow into the rotor channels.

2. A pressure exchanger according to claim 1, wherein the rotor outside surface contour is constructed as a plurality of blade elements distributed over the rotor surface.

3. A pressure exchanger according to claim 2, wherein a plurality of blade elements is arranged adjacent at least one rotor end face.

4. A pressure exchanger according to claim 2, wherein the blade elements are arranged on a rotor end face or in a transition area between the end face and the outer circumferential surface of the rotor.

5. A pressure exchanger according to claim 1, wherein the rotor surface contour comprises at least one spiral groove formed in the outer circumferential surface of the rotor.

6. A pressure exchanger according to claim 1, wherein at least one partial stream withdrawn from the first liquid system is directed toward the rotor surface contour.

7. A pressure exchanger according to claim 1, wherein a liquid main stream remaining after diversion of the partial stream from the mass flow of liquid through the pressure exchanger, flows essentially without shock into the rotor channels.

8. A pressure exchanger according to claim 7, wherein when the overall flow through the pressure exchanges changes, essentially shock free flow into the rotor channels is maintained by adjusting the rotor speed.

9. A pressure exchanger according to claim 1, wherein the arcuately shaped cavities each comprise a diffuser part downstream from the connection openings and a subsequent deflector part which includes one of the flow openings in the housing.

10. A pressure exchanger according to claim 1, wherein the regulator comprises a throttle arranged in the flow path of the partial stream for controlling the flow rate of the partial stream.

11. A pressure exchanger for transferring pressure energy from a high pressure liquid of a first liquid system to a low pressure liquid of a second liquid system comprising a housing with inlet and outlet connection openings for each liquid and a rotor arranged in the housing for rotation about a longitudinal axis, said rotor having a plurality of continuous channels arranged around the longitudinal axis with openings on each rotor end face such that the rotor channels are connected with the inlet and outlet connection openings through flow openings in the housing so that during the rotation of the rotor the channels alternately carry high pressure liquid and low pressure liquid from the respective liquid systems; wherein:
a predominantly axially extending flow transition is formed between the flow openings in the housing and the openings of the rotor channels;
the flow openings in the housing are parts of arcuately shaped cavities communicating with the connection openings, and each cavity simultaneously covers a plurality of rotor channel openings and has a contour that makes the velocity of flow uniform in the area of the housing flow openings;
an external drive drives the rotor via a shaft; and
a regulator regulates the speed of the external drive as a function of the system conditions and thereby controls the rotor speed for essentially shock-free admission of the liquid flow into the rotor channels.

12. A pressure exchanger according to claim 11, wherein the mass flow of the liquids arrives as oncoming flow in the rotor channels essentially without shock.

13. A pressure exchanger according to claim 1, wherein a further regulator is connected to at least one sensor arranged to sense the operating state of at least one of the liquid systems and adjusts the partial stream or the rotor speed in response to a change in the sensed operating state.

14. A pressure exchanger according to claim 11, wherein a further regulator is connected to at least one sensor arranged to sense the operating state of at least one of the liquid systems and adjusts the speed of the drive and rotor speed in response to a change in the sensed operating state.

15. A pressure exchanger according to claim 1, wherein a further regulator detects the rotational speed of the rotor and produces an actuating signal for speed control of at least one pump in at least one of the liquid systems in response to the detected rotor speed.

16. A pressure exchanger according to claim 11, wherein a further regulator detects the rotational speed of the rotor and produces an actuating signal for speed control of at least one pump in at least one of the liquid systems in response to the detected rotor speed.

17. A pressure exchanger according to claim 1, wherein a further regulator is connected to a discharge line for discharging low pressure liquid from the pressure exchanger and equilibrates the incoming low pressure liquid stream to the outgoing high pressure liquid stream.

18. A pressure exchanger according to claim 11, wherein a further regulator is connected to a discharge line for discharging low pressure liquid from the pressure exchanger and equilibrates the incoming low pressure liquid stream to the outgoing high pressure liquid stream.
